(19) United States
(12) Patent Application Publication
(10) Pub. No.: US 2026/0079362 A1
(43) Pub. Date: Mar. 19, 2026

(54) OPTICAL COMB LIGHT SOURCE AND MEASURING APPARATUS

(71) Applicant: ADVANTEST CORPORATION, Tokyo (JP)

(72) Inventors: Takao SAKURAI, Miyagi (JP); Shin MASUDA, Miyagi (JP); Takanori OKADA, Miyagi (JP)

(73) Assignee: ADVANTEST CORPORATION, Tokyo (JP)

(21) Appl. No.: 19/270,650

(22) Filed: Jul. 16, 2025

(30) Foreign Application Priority Data
Sep. 17, 2024 (JP) 2024-159719

(51) Int. Cl. G02F 1/11; G02F 1/01

(52) U.S. Cl. CPC G02F 1/113; G02F 1/0121

(57) ABSTRACT

An optical comb light source outputs an optical comb having a plurality of modes. The optical comb light source includes an optical comb generating section, an optical frequency changing section, and a mode optical frequency controlling section. The optical comb generating section generates the optical comb. The optical frequency changing section receives a reference wavelength light having a predetermined optical frequency and changes the optical frequency of the reference wavelength light for output. The mode optical frequency controlling section controls a mode optical frequency that is an optical frequency of one mode of the plurality of modes such that a difference between the mode optical frequency and a target optical frequency that is an optical frequency of an output from the optical frequency changing section has a predetermined value. The optical comb generating section changes optical frequencies of the plurality of modes according to the controlled mode optical frequency.

### BACKGROUND OF THE INVENTION

### Field of the Invention

The present invention relates to controlling the optical frequency of an optical comb.

### Description of the Related Art

In conventionally known certain optical comb light sources, the frequency of a carrier envelope offset signal is set to a predetermined value, and the frequency of a beat signal between an output from a reference wavelength light source and one mode of the optical comb is set to a predetermined value, to stabilize the frequency of the optical comb. It should be noted that the optical frequency of the output from the reference wavelength light source is controlled with a high degree of accuracy according to, for example, the frequency of the absorption line of gas. In addition, the carrier envelope offset signal can be synchronized in phase with a certain RF reference signal and the beat signal can be synchronized in phase with another RF reference signal to cause the frequency of the beat signal to match the frequency of the other RF reference signal. Further, the frequency f_{beat} of the beat signal is a difference between the optical frequency νcw of the output from the reference wavelength light source and the optical frequency νm of one mode of the optical comb.

In conventionally known other optical comb light sources, the repetition frequency of the optical comb is caused to match the output frequency of an RF synthesizer to stabilize the frequency of the optical comb (see Japanese Patent Application Publication No. 2004-077979 and Sho Okubo and five others, “Near-infrared broadband dual-frequency-comb spectroscopy with a resolution beyond the Fourier limit determined by the observation time window,” Optics Express, December 2015, Vol. 23, No. 26, p. 33184-33193, for example).

### SUMMARY OF THE INVENTION

It may be requested here, in certain optical comb light sources of such a related art as described above, to change the optical frequency νm of one mode of the optical comb. In this case, it can only be required to change the frequency f_{beat} of the beat signal to change the optical frequency νm.

However, f_{beat} should be lower than fᵣₑₚ/2 (where fᵣₑₚ is the repetition frequency of the optical comb). This is for the reason that if f_{beat} is equal to or higher than fᵣₑₚ/2, fᵣₑₚ−f_{beat} is equal to or lower than f_{beat} and thus the component of fᵣₑₚ−f_{beat} cannot be ignored. Accordingly, the range within which the optical frequency νm can be changed is limited.

It is hence an object of the present invention to allow the optical frequency of one mode of an optical comb to be changed by more than half of the repetition frequency of the optical comb.

According to the present invention, an optical comb light source that outputs an optical comb having a plurality of modes, includes: an optical comb generating section arranged to generate the optical comb; an optical frequency changing section arranged to receive a reference wavelength light having a predetermined optical frequency and to change the optical frequency of the reference wavelength light for output; and a mode optical frequency controlling section arranged to control a mode optical frequency that is an optical frequency of one mode of the plurality of modes such that a difference between the mode optical frequency and a target optical frequency that is an optical frequency of an output from the optical frequency changing section has a predetermined value, wherein the optical comb generating section is arranged to change optical frequencies of the plurality of modes according to the controlled mode optical frequency to provide an output from the optical comb light source.

The thus constructed optical comb light source outputs an optical comb having a plurality of modes. An optical comb generating section generates the optical comb. An optical frequency changing section receives a reference wavelength light having a predetermined optical frequency and changes the optical frequency of the reference wavelength light for output. A mode optical frequency controlling section controls a mode optical frequency that is an optical frequency of one mode of the plurality of modes such that a difference between the mode optical frequency and a target optical frequency that is an optical frequency of an output from the optical frequency changing section has a predetermined value. The optical comb generating section changes optical frequencies of the plurality of modes according to the controlled mode optical frequency to provide an output from the optical comb light source.

According to the optical comb light source of the present invention, the optical frequency changing section may be an acousto-optic modulator.

According to the optical comb light source of the present invention, the predetermined value may be smaller than one-half of a repetition frequency of the optical comb.

According to the optical comb light source of the present invention, an amount of change in the optical frequency of the reference wavelength light by the optical frequency changing section may be variable.

According to the optical comb light source of the present invention, a maximum value and a minimum value of the amount of change may have a difference equal to or greater than one-half of a repetition frequency of the optical comb.

According to the optical comb light source of the present invention, a maximum value and a minimum value of the amount of change may have a difference equal to or greater than a repetition frequency of the optical comb.

According to the optical comb light source of the present invention, the optical frequency of the reference wavelength light may be defined based on an optical frequency of an absorption line of predetermined gas.

According to the optical comb light source of the present invention, the optical comb generating section may be arranged to change an optical frequency of a mode near the one mode by the amount of variation in the amount of change.

According to the optical comb light source of the present invention, the one mode is an m-th mode (where m represents an integer equal to or greater than 1), and provided that a remainder of the mode optical frequency divided by a repetition frequency of the optical comb defines a carrier envelope offset frequency, the optical comb generating section may be arranged to change the repetition frequency to be a value obtained by subtracting the carrier envelope offset frequency from the controlled mode optical frequency and dividing the result by m.

According to the present invention, a measuring apparatus includes: the two optical comb light sources; an interference signal acquiring section arranged to acquire an interference signal between a post-irradiation optical comb generated when a device under test is irradiated with an output from one of the optical comb light sources and an output from the other of the optical comb light sources; and a frequency spectrum measuring section arranged to measure a frequency spectrum of a result of acquisition by the interference signal acquiring section.

The thus constructed measuring apparatus includes the two thus constructed optical comb light sources. An interference signal acquiring section is arranged to acquire an interference signal between a post-irradiation optical comb generated when a device under test is irradiated with an output from one of the optical comb light sources and an output from the other of the optical comb light sources. A frequency spectrum measuring section is arranged to measure a frequency spectrum of a result of acquisition by the interference signal acquiring section.

### BRIEF DESCRIPTION OF THE DRAWINGS

FIG. 1 is a functional block diagram showing a configuration of an optical comb light source 1 according to a first embodiment of the present invention;

FIG. 2 shows a frequency spectrum of an optical comb;

FIGS. 3(a), 3(b), 3(c), and 3(d) show frequency spectrums of an output from an optical frequency changing section 14 and an output from an optical comb generating section 11 when f_{AO} is f_{AO1} (=60 MHz) (FIG. 3(a)), f_{AO} is f_{AO2} (=90 MHz) (FIG. 3(b)), f_{AO} is f_{AO3} (=100 MHz) (FIG. 3(c)), and f_{AO} is f_{AO4} (=110 MHz) (FIG. 3(d)); and

FIG. 4 is a functional block diagram showing a configuration of a measuring apparatus 100 according to a second embodiment of the present invention.

### DESCRIPTION OF THE PREFERRED EMBODIMENT

Preferred embodiments of the present invention will hereinafter be described with reference to the accompanying drawings.

### First Embodiment

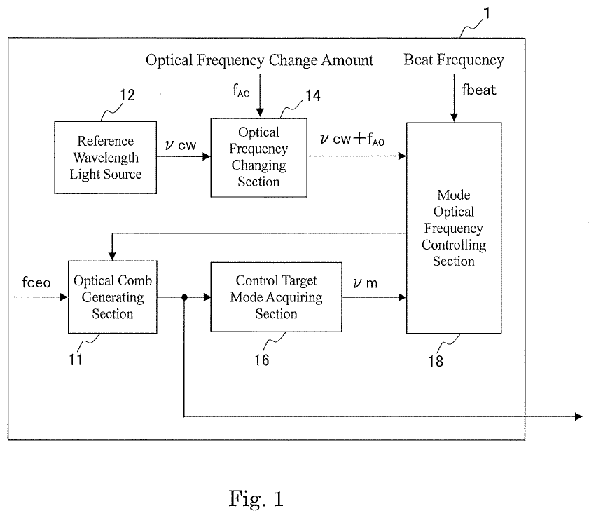

FIG. 1 is a functional block diagram showing the configuration of an optical comb light source 1 according to a first embodiment of the present invention. The optical comb light source 1 according to the first embodiment includes an optical comb generating section 11, a reference wavelength light source 12, an optical frequency changing section 14, a control target mode acquiring section 16, and a mode optical frequency controlling section 18.

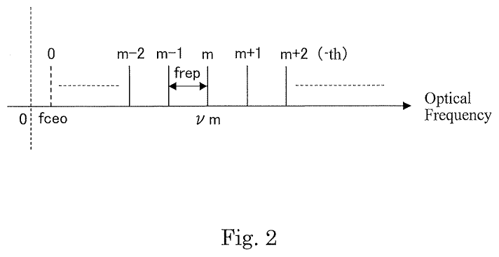

FIG. 2 shows a frequency spectrum of an optical comb. The optical comb generating section 11 is arranged to generate an optical comb. It is noted that the vertical axis represents the optical power in FIG. 2. Referring to FIG. 2, the optical comb has multiple modes (e.g. m−2-th, m−1-th, m−th, m+1-th, m+2-th modes). The m-th frequency spectrum of the optical comb has a frequency νm=f_{ceo}'m·fᵣₑₚ (repetition frequency fᵣₑₚ). Note here that f_{ceo} represents a carrier envelope offset frequency, which is a remaining frequency when the optical comb is extrapolated to the 0th frequency. It is noted that the optical comb light source 1 is arranged to output an optical comb generated by the optical comb generating section 11 and having multiple modes.

It is also noted that the carrier envelope offset frequency is stabilized. For example, the carrier envelope offset frequency is stabilized by synchronizing a signal at the carrier envelope offset frequency in phase with a predetermined RF reference signal. The control target mode acquiring section 16 is arranged to acquire one mode (e.g. the m-th mode, having an optical frequency νm) (where m represents an integer equal to or greater than 1) from the multiple modes of the optical comb generated by the optical comb generating section 11. The optical frequency of the one mode is referred to as mode optical frequency νm. It is noted that the carrier envelope offset frequency f_{ceo} can also be a remainder of the mode optical frequency νm divided by the repetition frequency fᵣₑₚ of the optical comb.

The reference wavelength light source 12 is arranged to output a reference wavelength light (having an optical frequency νcw). It is noted that the optical frequency νcw of the reference wavelength light is defined based on the optical frequency of the absorption line of predetermined gas and controlled with a high degree of accuracy.

The optical frequency changing section 14 is arranged to receive a reference wavelength light having a predetermined optical frequency νcw from the reference wavelength light source 12 and to change the optical frequency νcw of the reference wavelength light by an optical frequency change amount f_{AO} for output. The output has an optical frequency (referred to as target optical frequency) νcw+f_{AO}.

The optical frequency changing section 14 is, for example, an acousto-optic modulator (AOM). In this case, the output from the optical frequency changing section 14 includes little component of the reference wavelength light (with the optical frequency νcw) mixed therein. In addition, the reference wavelength light is output from the optical frequency changing section 14 with little attenuation. Accordingly, the optical frequency changing section 14 is preferably an acousto-optic modulator.

Note here that the optical frequency changing section 14 may not be an acousto-optic modulator but a device for phase modulation. However, in this case, the output from the optical frequency changing section 14 includes a significant amount of component of the reference wavelength light (with the optical frequency νcw) and component of the sideband wave mixed therein. It is hence contemplated that a filter or the like may be used to reduce these components.

The mode optical frequency controlling section 18 is arranged to control the mode optical frequency νm such that the difference between the mode optical frequency νm and the target optical frequency νcw+f_{AO} has a predetermined value (beat frequency) f_{beat}.

The optical comb generating section 11 is arranged to change optical frequencies of the multiple modes according to the controlled mode optical frequency νm to provide an output from the optical comb light source 1.

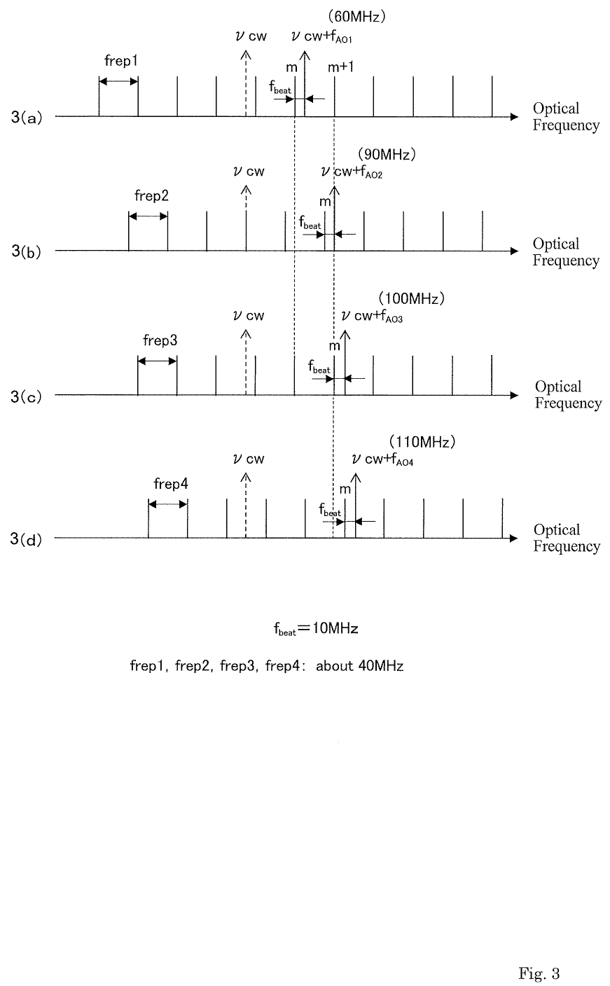

FIGS. 3(a), 3(b), 3(c), and 3(d) show frequency spectrums of an output from an optical frequency changing section 14 and an output from an optical comb generating section 11 when f_{AO} is f_{AO1} (=60 MHz) (FIG. 3(a)), f_{AO} is f_{AO2} (=90 MHz) (FIG. 3(b)), f_{AO} is f_{AO3} (=100 MHz) (FIG. 3(c)), and f_{AO} is f_{AO4} (=110 MHz) (FIG. 3(d)). It is noted that in FIG. 3, the frequency spectrums of the output from the optical frequency changing section 14 are indicated by the vertical arrows, while the frequency spectrums of the output from optical comb generating section 11 are indicated by the equally spaced upright lines.

The predetermined value f_{beat} is smaller than one-half of the repetition frequency fᵣₑₚ of the optical comb. For example, since the predetermined value f_{beat}=10 MHz and the optical comb has repetition frequencies fᵣₑₚ₁, fᵣₑₚ₂, fᵣₑₚ₃, and fᵣₑₚ₄ of about 40 MHz, the predetermined value f_{beat} is smaller than one-half of the repetition frequencies of the optical comb.

Note here that:
the repetition frequency fᵣₑₚ₁ of the optical comb is a repetition frequency of the optical comb when f_{AO} is f_{AO1} (=60 MHz) (see FIG. 3(a));
the repetition frequency fᵣₑₚ₂ of the optical comb is a repetition frequency of the optical comb when f_{AO} is f_{AO2} (=90 MHz) (see FIG. 3(b));
the repetition frequency fᵣₑₚ₃ of the optical comb is a repetition frequency of the optical comb when f_{AO} is f_{AO3} (=100 MHz) (see FIG. 3(c)); and
the repetition frequency fᵣₑₚ₄ of the optical comb is a repetition frequency of the optical comb when f_{AO} is f_{AO4} (=110 MHz) (see FIG. 3(d)).

It is noted that the change amount f_{AO} of the optical frequency νcw of the reference wavelength light by the optical frequency changing section 14 is variable.

The maximum value and the minimum value of the change amount f_{AO} may have a difference equal to or greater than one-half of the repetition frequency fᵣₑₚ of the optical comb. For example, in a case where the minimum value of the change amount f_{AO} is f_{AO1} (=60 MHz) (see FIG. 3(a)) and the maximum value of the change amount f_{AO} is f_{AO2} (=90 MHz) (see FIG. 3(b)), 90−60=30 MHz is equal to or greater than one-half of fᵣₑₚ (about 20 MHz).

The maximum value and the minimum value of the change amount f_{AO} may have a difference equal to or greater than the repetition frequency fᵣₑₚ of the optical comb. For example, in a case where the minimum value of the change amount f_{AO} is f_{AO1} (=60 MHz) (see FIG. 3(a)) and the maximum value of the change amount f_{AO} is f_{AO3} (=100 MHz) (see FIG. 3(c)), 100−60=40 MHz is equal to or greater than fᵣₑₚ (about 40 MHz).

For example, in a case where the minimum value of the change amount f_{AO} is f_{AO1} (=60 MHz) (see FIG. 3(a)) and the maximum value of the change amount f_{AO} is f_{AO4} (=110 MHz) (see FIG. 3(d)), 110−60=50 MHz is equal to or greater than fᵣₑₚ (about 40 MHz).

The optical comb generating section 11 is arranged to change the repetition frequency fᵣₑₚ to be a value obtained by subtracting the carrier envelope offset frequency f_{ceo} from the mode optical frequency νm controlled by the mode optical frequency controlling section 18 and dividing the result by m.

It is assumed that νcw=194.36985 THz, the predetermined value f_{beat}=10 MHz, the carrier envelope offset frequency f_{ceo}=30 MHz, m=4,859,247, for example. When f_{AO} is f_{AO1} (=60 MHz) (see FIG. 3(a)), the optical comb has a repetition frequency fᵣₑₚ₁ of 39,999,997.94 Hz (about 40 MHz) and a mode optical frequency νm of 194.36990 THz.

It is here assumed that the optical frequency changing section 14 has varied the change amount f_{AO} of the optical frequency νcw of the reference wavelength light from f_{AO1} (=60 MHz) to f_{AO2} (=90 MHz) (see FIG. 3(b)).

The mode optical frequency controlling section 18 is arranged to control the mode optical frequency νm such that the difference between the mode optical frequency νm and the target optical frequency νcw+f_{AO} has a predetermined value f_{beat}. In the case above, since the change amount f_{AO} increases by 90−60=30 MHz, the mode optical frequency controlling section 18 controls the mode optical frequency νm to also increase by 30 MHz. The mode optical frequency νm then increases to 194.36993 THz.

The optical comb generating section 11 is here arranged to change the repetition frequency fᵣₑₚ to be a value obtained by subtracting the carrier envelope offset frequency f_{ceo} from the mode optical frequency νm controlled by the mode optical frequency controlling section 18 and dividing the result by m. That is, the repetition frequency fᵣₑₚ is changed to fᵣₑₚ₂=40,000,004.12 Hz (about 40 MHz). The repetition frequency fᵣₑₚ₂ is higher than the repetition frequency fᵣₑₚ₁ by 6.18 Hz.

It is noted that the repetition frequency fᵣₑₚ₂ and the repetition frequency fᵣₑₚ₁ can be considered approximately equal to each other (about 40 MHz). It can therefore be considered that by the shift amount (90−60=30 MHz) of the optical frequency of one mode (the m-th mode), the optical frequency of a mode near the one mode (the m-th mode) is changed with the repetition frequency kept constant.

It is noted that the shift amount of the optical frequency of one mode (the m-th mode) can be considered the variation amount f_{AO2}−f_{AO1}=30 MHz in the change amount f_{AO}. It can therefore be considered that the optical comb generating section 11 changes the optical frequency of the mode near the one mode (the m-th mode) by the variation amount f_{AO2}−f_{AO1}=30 MHz in the change amount f_{AO}.

The same applies to the case where the optical frequency changing section 14 has varied the change amount f_{AO} of the optical frequency νcw of the reference wavelength light from f_{AO1} (=60 MHz) to f_{AO3} (=100 MHz) (see FIG. 3(c)) (or f_{AO4} (=110 MHz) (see FIG. 3(d))).

That is, the repetition frequency fᵣₑₚ₃ or fᵣₑₚ₄ is changed, as is the case with above. It can alternatively be considered that the optical comb generating section 11 changes the optical frequency of the mode near the one mode (the m-th mode) by the variation amount f_{AO3}−f_{AO1}=40 MHz (or f_{AO4}−f_{AO1}=50 MHz) in the change amount f_{AO}. In this case, referring to FIG. 3(c), the one mode (the m-th mode) can be changed to the same optical frequency as the m+1-th mode in FIG. 3(a). Further, referring to FIG. 3(d), the one mode (the m-th mode) can be changed to an optical frequency higher by 10 MHz than the m+1-th mode in FIG. 3(a).

Next will be described an operation according to the first embodiment.

From an optical comb (see FIG. 2) generated by the optical comb generating section 11, one mode (the m-th mode) is acquired by the control target mode acquiring section 16, and a signal having a mode optical frequency νm is provided to the mode optical frequency controlling section 18.

A reference wavelength light (having an optical frequency νcw) output from the reference wavelength light source 12 is changed by an optical frequency change amount f_{AO} through the optical frequency changing section 14, and a signal having a target optical frequency νcw+f_{AO} is provided to the mode optical frequency controlling section 18. The optical frequency change amount f_{AO} can be varied from 60 MHz to 90 MHz (or 100 MHz or 110 MHz).

The mode optical frequency controlling section 18 controls the mode optical frequency νm such that the difference between the mode optical frequency νm and the target optical frequency νcw+f_{AO} has a predetermined value f_{beat}=10 MHz. That is, it is only required to change the mode optical frequency νm by the variation in the optical frequency change amount f_{AO}.

For example, when the change amount f_{AO} of the optical frequency νcw of the reference wavelength light is varied from f_{AO1} (=60 MHz) (see FIG. 3(a)) to f_{AO2} (=90 MHz) (see FIG. 3(b)), it is only required to increase the mode optical frequency νm by 30 MHz.

The optical comb generating section 11 changes optical frequencies of the multiple modes according to the controlled mode optical frequency νm to provide an output from the optical comb light source 1. For example, the optical comb generating section 11 changes the repetition frequency fᵣₑₚ to be a value obtained by subtracting the carrier envelope offset frequency f_{ceo} from the mode optical frequency νm controlled by the mode optical frequency controlling section 18 and dividing the result by m.

For example, the repetition frequency fᵣₑₚ₂ (see FIG. 3(b)) is made higher than the repetition frequency fᵣₑₚ₁ (see FIG. 3(a)) by 6.18 Hz, as described above.

Alternatively, if the repetition frequency near the m-th mode is considered constant at about 40 MHz regardless of the variation in the optical frequency change amount f_{AO}, it is only required to change the optical frequency of the mode near the m-th mode by the variation amount in the optical frequency change amount f_{AO} (i.e. the shift amount of the mode optical frequency νm).

For example, when the change amount f_{AO} of the optical frequency νcw of the reference wavelength light is varied from f_{AO1} (=60 MHz) (see FIG. 3(a)) to f_{AO2} (=90 MHz) (see FIG. 3(b)), the mode optical frequency νm and the optical frequency of the mode near the m-th mode are increased by 30 MHz.

For example, when the change amount f_{AO} of the optical frequency νcw of the reference wavelength light is varied from f_{AO1} (=60 MHz) (see FIG. 3(a)) to f_{AO3} (=100 MHz) (see FIG. 3(c)), the mode optical frequency νm and the optical frequency of the mode near the m-th mode are increased by 40 MHz.

For example, when the change amount f_{AO} of the optical frequency νcw of the reference wavelength light is varied from f_{AO1} (=60 MHz) (see FIG. 3(a)) to f_{AO4} (=110 MHz) (see FIG. 3(d)), the mode optical frequency νm and the optical frequency of the mode near the m-th mode are increased by 50 MHz.

In accordance with the first embodiment, the optical frequency νm of one mode of the optical comb can be changed by more than half of the repetition frequency fᵣₑₚ of the optical comb. Accordingly, the frequency of the optical comb can be shifted.

That is, unless the predetermined value f_{beat} is equal to or greater than one-half of the repetition frequency of the optical comb, even if the mode optical frequency νm may be changed by more than half of the repetition frequency fᵣₑₚ, the predetermined value f_{beat} remains smaller than one-half of the repetition frequency of the optical comb.

### Second Embodiment

A measuring apparatus 100 according to a second embodiment includes an optical comb light source 1 according to the first embodiment and an optical comb light source 2 similar thereto, and is arranged to measure a device under test (DUT) 4.

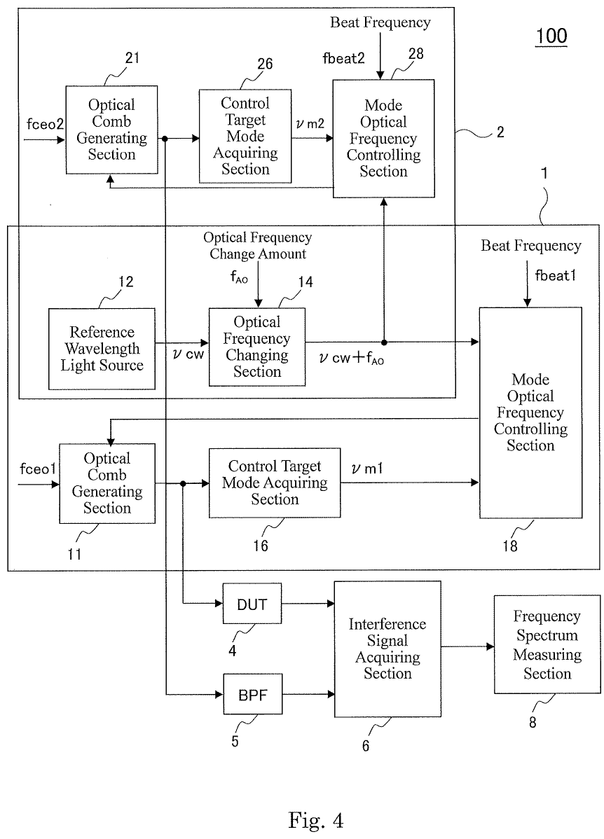

FIG. 4 is a functional block diagram showing the configuration of the measuring apparatus 100 according to the second embodiment of the present invention. The measuring apparatus 100 according to the second embodiment includes (one) optical comb light source 1, (the other) optical comb light source 2, a band pass filter (BPF) 5, an interference signal acquiring section 6, and a frequency spectrum measuring section 8.

The (one) optical comb light source 1 is the same as that in the first embodiment and will not be described, except that the carrier envelope offset frequency is f_{ceo1}, the mode optical frequency is νm1, and the beat frequency is f_{beat1}.

The (other) optical comb light source 2 includes an optical comb generating section 21, a reference wavelength light source 12, an optical frequency changing section 14, a control target mode acquiring section 26, and a mode optical frequency controlling section 28. The reference wavelength light source 12 and the optical frequency changing section 14 are also included in the (one) optical comb light source 1.

The optical comb generating section 21, the control target mode acquiring section 26, and the mode optical frequency controlling section 28 are, respectively, the same as the optical comb generating section 11, the control target mode acquiring section 16, and the mode optical frequency controlling section 18 included in the (one) optical comb light source 1 and will not be described.

Note here that in the (other) optical comb light source 2, the carrier envelope offset frequency is f_{ceo2}, the mode optical frequency is νm2, and the beat frequency is f_{beat2}. In addition, the repetition frequency of an optical comb generated by the optical comb generating section 11 is slightly different from the repetition frequency of an optical comb generated by the optical comb generating section 21.

It is noted that an optical comb output from the (other) optical comb light source 2 is arranged to be provided to the band pass filter (BPF) 5 without passing through the (one) optical comb light source 1.

The device under test (DUT) 4 is, for example, gas in a gas cell. The device under test 4 is arranged to be irradiated with an optical comb output from the (one) optical comb light source 1. An optical comb obtained by irradiating the device under test 4 with the optical comb output from the (one) optical comb light source 1 is referred to as post-irradiation optical comb.

The band pass filter (BPF) 5 is arranged to be irradiated with an optical comb output from the (other) optical comb light source 2.

The interference signal acquiring section 6 is arranged to acquire an interference signal between the post-irradiation optical comb and an output from the (other) optical comb light source 2 after passing through the band pass filter 5. The frequency spectrum measuring section 8 is arranged to measure the frequency spectrum of a result of acquisition by the interference signal acquiring section 6.

In accordance with the second embodiment, the optical frequency νm of one mode of the optical comb can be changed by more than half of the repetition frequency of the optical comb. In addition, with the change in the mode optical frequency νm, the frequencies of the optical combs output from the optical comb light source 1 and the optical comb light source 2 can be shifted in the measuring apparatus 100.

### DESCRIPTION OF REFERENCE NUMERALS

1 (One) Optical Comb Light Source
2 (The Other) Optical Comb Light Source
4 Device Under Test (DUT)
5 Band Pass Filter (BPF)
6 Interference Signal Acquiring Section
8 Frequency Spectrum Measuring Section
100 Measuring Apparatus
11, 21 Optical Comb Generating Section
12 Reference Wavelength Light Source
14 Optical Frequency Changing Section
16, 26 Control Target Mode Acquiring Section
18, 28 Mode Optical Frequency Controlling Section
f_{ceo}, f_{ceo1}, f_{ceo2} Carrier Envelope Offset Frequency
νcw Optical Frequency of Reference Wavelength Light
f_{AO}, f_{AO1}, f_{AO2}, f_{AO3}, f_{AO4} Optical Frequency Change Amount
νm, νm1, νm2 Mode Optical Frequency
fᵣₑₚ, fᵣₑₚ₁, fᵣₑₚ₂, fᵣₑₚ₃, fᵣₑₚ₄ Repetition Frequency
f_{beat} Beat Frequency

What is claimed is:

1. An optical comb light source that outputs an optical comb having a plurality of modes, comprising:
an optical comb generating section arranged to generate the optical comb;
an optical frequency changing section arranged to receive a reference wavelength light having a predetermined optical frequency and to change the optical frequency of the reference wavelength light for output; and
a mode optical frequency controlling section arranged to control a mode optical frequency that is an optical frequency of one mode of the plurality of modes such that a difference between the mode optical frequency and a target optical frequency that is an optical frequency of an output from the optical frequency changing section has a predetermined value, wherein
the optical comb generating section is arranged to change optical frequencies of the plurality of modes according to the controlled mode optical frequency to provide an output from the optical comb light source.

2. The optical comb light source according to claim 1, wherein
the optical frequency changing section is an acousto-optic modulator.

3. The optical comb light source according to claim 1, wherein
the predetermined value is smaller than one-half of a repetition frequency of the optical comb.

4. The optical comb light source according to claim 1, wherein
an amount of change in the optical frequency of the reference wavelength light by the optical frequency changing section is variable.

5. The optical comb light source according to claim 4, wherein
a maximum value and a minimum value of the amount of change has a difference equal to or greater than one-half of a repetition frequency of the optical comb.

6. The optical comb light source according to claim 4, wherein
a maximum value and a minimum value of the amount of change has a difference equal to or greater than a repetition frequency of the optical comb.

7. The optical comb light source according to claim 1, wherein
the optical frequency of the reference wavelength light is defined based on an optical frequency of an absorption line of predetermined gas.

8. The optical comb light source according to claim 4, wherein
the optical comb generating section is arranged to change an optical frequency of a mode near the one mode by the amount of variation in the amount of change.

9. The optical comb light source according to claim 1, wherein
the one mode is an m-th mode (where m represents an integer equal to or greater than 1), and
provided that a remainder of the mode optical frequency divided by a repetition frequency of the optical comb defines a carrier envelope offset frequency,
the optical comb generating section is arranged to change the repetition frequency to be a value obtained by subtracting the carrier envelope offset frequency from the controlled mode optical frequency and dividing the result by m.

10. A measuring apparatus, comprising:
two optical comb light sources according to claim 1;
an interference signal acquiring section arranged to acquire an interference signal between a post-irradiation optical comb generated when a device under test is irradiated with an output from one of the optical comb light sources and an output from the other of the optical comb light sources; and
a frequency spectrum measuring section arranged to measure a frequency spectrum of a result of acquisition by the interference signal acquiring section.
